(19) United States
(12) Patent Application Publication
(10) Pub. No.: US 2012/0109769 A1
(43) Pub. Date: May 3, 2012

(54) Method of Proximity Based Purchasing and Selling, and System Thereof

(76) Inventor: Philip Tucker, Holland, MI (US)

(21) Appl. No.: 12/964,383

(22) Filed: Dec. 9, 2010

Related U.S. Application Data
(60) Provisional application No. 61/407,049, filed on Oct. 27, 2010.

(51) Int. Cl. G06Q 30/00

(52) U.S. Cl. 705/26.2

(57) ABSTRACT

A method for proximity based purchasing and selling, and a system thereof are provided. The method includes the steps of determining a geographical location of a plurality of buyers, determining a product/service desired by at least a portion of the plurality of buyers, and grouping buyers by the determined geographical location and the desired product/service, such that a seller provides the product/service at a discounted rate as a result of the grouped buyers being in a geographical region and wanting a similar product/service.

### CROSS-REFERENCE TO RELATED APPLICATION

This application claims priority under 35 U.S.C. §119(e) to U.S. Provisional Patent Application No. 61/407,049, filed on Oct. 27, 2010, by Phillip Tucker, the entire disclosure of which is hereby incorporated herein by reference.

### FIELD OF THE INVENTION

The present invention generally relates to a method of proximity based purchasing and selling, and a system thereof, and more particularly, a method of purchasing and selling based upon a location of buyers and/or sellers.

### BACKGROUND OF THE INVENTION

Generally, on-line shopping allows for customers to purchase goods from sellers that the buyer might not otherwise have purchased from due to the geographical location of the two parties. Thus, a customer base of a seller can have a very large geographical area. Additionally, on-line shopping can make it difficult for local service providers to target advertising to people within a particular geographical region.

### SUMMARY OF THE INVENTION

According to one aspect of the present invention, a method for proximity based purchasing is provided that includes the steps of determining a geographical location of a plurality of buyers, determining a product/service desired by at least a portion of the plurality of buyers, and grouping buyers by the determined geographical location and the desired product/service, such that a seller provides the product/service at a discounted rate as a result of the grouped buyers being in a geographical region and wanting a similar product/service.

According to another aspect of the present invention, a method of proximity based purchasing is provided that includes the steps of determining a geographical location of a plurality of buyers, determining a product/service desired by at least a portion of the plurality of buyers, based upon at least a portion of a mailing address, and grouping buyers by the determined geographical location and the desired product/service, such that a seller provides the product/service at a discounted rate as a result of the grouped buyers being in a geographical region and wanting a similar product. The method further includes providing a tiered quote by the seller to geographical buyers and paying a commission to a service provider by the seller.

According to yet another aspect of the present invention, a system configured for proximity based purchasing is provided that includes a main controller in communication with a plurality of buyer devices, wherein at least a portion of the plurality of buyer devices includes a location determination device configured to determine a geographical location of the buyer device, a service selection device configured for selection of a desired product/service, and a communication device configured for communication with the main controller, wherein the main controller is configured to group the buyer devices by the determined location and the selected product/service, such that a seller provides a product/service at a discounted rate as a result of the grouped buyer devices being in a geographical region and wanting a similar product/service.

### BRIEF DESCRIPTION OF THE DRAWINGS

The present invention will now be described, by way of example, with reference to the accompanying drawings, in which

FIG. 1 is a flowchart illustrating a method of proximity based purchasing, in accordance with one embodiment of the present invention; and

FIG. 2 is a schematic diagram of a system configured for proximity based purchasing, in accordance with one embodiment of the present invention.

### DETAILED DESCRIPTION

Before describing in detail embodiments that are in accordance with the present invention, it should be observed that the embodiments include combinations of method steps and apparatus components related to a proximity based buying system. Accordingly, the apparatus components and method steps have been represented, where appropriate, by conventional symbols in the drawings, showing only those specific details that are pertinent to understanding the embodiments of the present invention so as not to obscure the disclosure with details that will be readily apparent to those of ordinary skill in the art having the benefit of the description herein. Further, like reference characters in the description and drawings represent like elements.

In this document, relational terms, such as first and second, top and bottom, and the like, may be used to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

According to one embodiment, a method for proximity based purchasing and/or selling can include the steps of determining a geographical location of a plurality of buyers, determining a product/service desired by at least a portion of the plurality of buyers, and grouping buyers based on the determined geographical location and the desired products/services, such that a seller provides the product/service at a discounted rate as a result of the group of buyers being in a geographical region and wanting a similar product/service, as described in greater detail herein. Thus, the proximity based purchasing can be where groups of buyers leverage their geographical proximity to negotiate discounts on common products/services.

For purposes of explanation and not limitation, the method for proximity based purchasing can be implemented as an Internet-based or web-based process that identifies potential buyers that live or work in proximity to each other. These buying groups can then be offered special discounts on the product/service based on pre-negotiated or quoted group rates and/or rates that are negotiated after the group is identified. Typically, geography can be a significant factor in the cost of certain products/services, and these costs can be greatly reduced if they are spread across a more concentrated group of buyers (e.g., buyers densely located within a geographical region).

According to one exemplary embodiment, the method for proximity based purchasing, when implemented, can include a group of buyers, such as a buyers desiring a snow plow service, which can be grouped geographically so that contractors (e.g., sellers) can bid (e.g., a quote) at discounted rates due to a more defined geographical location of their customers. Thus, the group of buyers receive a discounted rate due to their proximity and the associated savings to the contractor (e.g., the savings in costs and efficiency of servicing a localized customer base). Further, the contractor does not need to individually advertise to each buyer, but instead can use the service to reach a group of buyers. Typically, the seller or contractor pays a commission to the service provider based upon the service provider grouping these buyers together. Additionally or alternatively, the buyers can pay a commission to the service provider, the buyer and/or the seller can pay a flat rate to the service provider (e.g., a subscription), the like, or a combination thereof. It should be appreciated by those skilled in the art that additional or alternative forms of payments or business models to generate increased sales or revenues can be used, some of which are described in greater detail herein for purposes of explanation and not limitation.

Product/service and products/services can include one or more goods, one or more services, the like, or a combination thereof, according to one embodiment. It should be appreciated by those skilled in the art that the above-described snow plow service embodiment is for purposes of explanation and not limitation, and other exemplary embodiments can include, but are not limited to, lawn care, carpet cleaning, garbage collection, heating/cooling maintenance, in-home nursing care, housekeeping service, home delivery service, goods, the like, or a combination thereof.

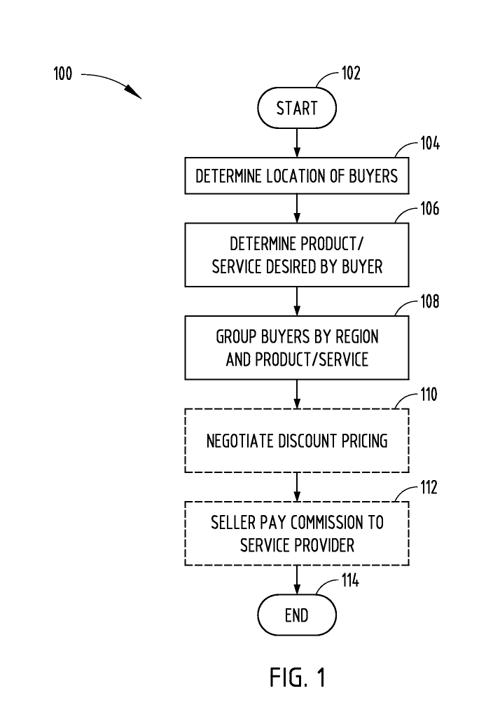

With respect to FIG. 1, a method for proximity based purchasing is generally shown at reference identifier 100. The method 100 can start at step 102, and proceed to step 104, wherein the location of buyers is determined. At step 106, the product/service desired by the buyer is determined, and at step 108, the buyers are grouped by region and the desired product/service. At step 110, discount pricing is negotiated. The discount pricing can either be pre-negotiated when the seller contracts with a service provider (e.g., a web-based supplier of the method 100), or the discount pricing can be negotiated with the buyers after the buyers have been grouped. Typically, the seller pays a commission to the service provider at step 112, and the method 100 then ends at step 114. Alternatively, the method 100 can proceed from step 108, and end at step 114, as illustrated in FIG. 1 by steps 110 and 112 being shown in phantom.

According to an embodiment, wherein step 110 is removed, the seller can submit quotes based upon the number of buyers that are grouped within a particular geographical region (e.g., a tiered quote) prior to the buyers being grouped. By way of explanation and not limitation, the seller can provide quotes for groups of one, two, five, twenty, fifty, etc. buyer(s). Further, multiple sellers can submit such quotes, so that once a group of buyers is formed, the seller can win the bid based upon their quotes.

With respect to an embodiment of the method 100 that includes step 110, the negotiation between the grouped buyers and the sellers can be approximately real-time. Thus, new buyers can be added to the group as the bidding is taking place. Additionally or alternatively, new sellers can be added to the group during the bidding process, sellers can see they are being under-bid and submit lower quotes, the like, or a combination thereof. However, it should be appreciated by those skilled in the art that the negotiation of a discounted price can be non-real-time.

According to one embodiment, the geographical location can be based upon a nine digit zip code. However, it should be appreciated by those skilled in the art that additional or alternative forms of geographical location can be used to group the buyers, such as, but not limited to, a five digit zip code, a country, a street, a city, a state, a school district, a voting district, a county, at least a portion of a mailing address, global positioning satellite (GPS) system coordinates, a location determined by a cellular connection, an area code, radio-frequency identification (RFID), the like, or a combination thereof. Thus, the geographical location or region that is used to group the buyers can be any size (e.g., one or more adjacent zip codes, etc.), wherein the size can be based upon the number of buyers, the product/service provided, the like, or a combination thereof.

Additionally or alternatively, the seller's can have a satisfaction rating that is based upon previous buyers', or a group of buyers', input. The seller can win the bid based upon a combination of their quote and their satisfaction rating. The combination of the quote and the satisfaction rating can be approximately an even consideration or a weighted consideration (e.g., more emphasis on the quote or the satisfaction rating). Thus, a group of buyers do not have to accept the lowest bid if the group chooses to accept a higher price because the higher bidding seller has a greater satisfaction rating. It should be appreciated by those skilled in the art that other suitable variables can be used to determine the seller that wins the bid.

According to one embodiment, a group of buyers can be identified, wherein the group of buyers bid or auction for the product/service. Thus, the seller can place bids based upon the known group, and attempt to win the business over other sellers. In such an embodiment, the group of buyers can provide their desired pricing to the sellers.

The service provider can sell advertisements to sellers, which can be displayed to the buyers, according to one embodiment. The advertisements can be displayed to the buyers at random, by the determined geographical location, by the desired product/service, the like, or a combination thereof.

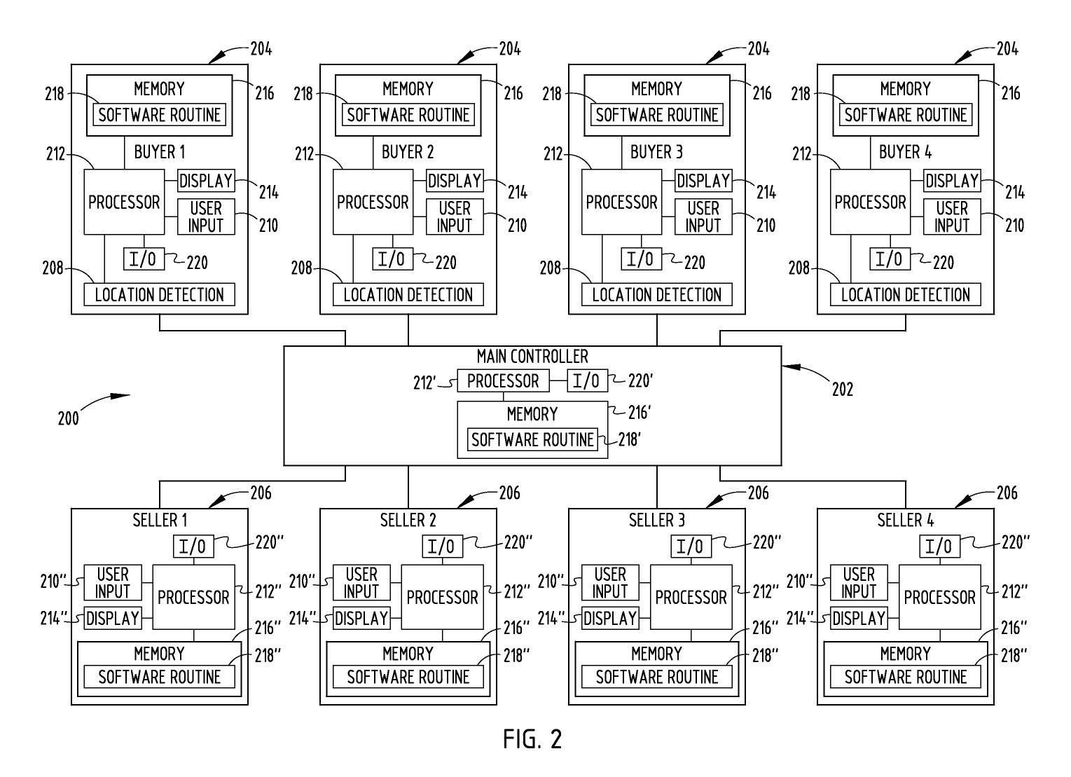

With respect to FIG. 2, a system for proximity based purchasing is generally shown at reference identifier 200. The system 200 can include a master controller generally indicated at reference identifier 202, that is in communication with a plurality of buyer devices generally indicated at reference identifier 204. Typically, the master controller 202 is the provider of the method or service of proximity based purchasing (e.g., a web-based provider). In such an embodiment, the master controller 202 can be one or more servers (at one or more locations) configured to receive and process data from the plurality of buyer devices 204, execute one or more software routines to process the revised data, communicate with one or more seller devices generally indicated at reference identifier 206, receive and process data from the seller device 206, the like, or a combination thereof.

At least a portion of the plurality of buyer devices 204 can include a location determination device 208 configured to determine a geographical location of the buyer device 204, a service selection device (e.g., a user input device 210) configured for selection of a desired service, and a communication device configured for communication with the main controller 202. Typically, the main controller 202 can be configured to group the buyer devices 204 by the determined location and the selected product/service, such that a seller 206 provides a product/service at a discounted rate as a result of the group of buyer devices 204 being in a geographical region and wanting a similar product/service, as described in greater detail herein.

The location determination device 208 can be configured so that the location is entered by a user or determined via an automation device. An embodiment, where the location is entered by the user can be where the buyer device 204 is a computer or other suitable device with a user input device 210, such that the user enters a location (e.g., a nine-digit zip code). The buyer device 204 can also be a mobile device or a non-mobile device that has an automation device configured for determining location, such as GPS coordinates or a cellular connection.

It should be appreciated by those skilled in the art that the system 200 can include suitable devices for wired and/or wireless (long and short range) communication. Thus, the buyer devices 204 and the seller devices 206 can be personal computers, telephones, smartphones, personal digital assistants (PDAs), laptops, electronic tablets (e.g., iPAD™, KINDLET™), the like, or a combination thereof. Typically, the buyer devices 204 and the seller devices 206 include user input devices 210, such as, but not limited to, a key board, a mouse, a touch screen, a touch pad, a microphone, the like, or a combination thereof.

As exemplary illustrated in FIG. 2, the buyer device 204 can include the location determination device 208, the user input device 210, a processor 212 configured to process data and communicate control signals, a display 214, a memory 216 configured to store one or more executable software routines 218, an input/output (I/O) device 220 (e.g., a communication device) configured to communicate with the master controller 202, the seller device 206, the like, or a combination thereof. The master controller 202 can include a processor 212′, a memory 216′ configured to execute one or more executable software routines 218′, an I/O device 220′ (e.g., a communication device), the like, or a combination thereof. The seller device 206 can include a user input device 210″, a processor 212″, a display 214″, a memory 216″ configured to execute one or more executable software routines 218″, an I/O device 220″ (e.g., a communication device), the like, or a combination thereof.

Although the method 100 and system 200 are described above as having a plurality of buyers/buyer devices and a plurality of seller/seller devices, for purposes of explanation and not limitation, it should be appreciated by those skilled in the art that the method 100 and system 200 can include a single buyer/buyer device and/or a single seller/seller device. In such an embodiment, only a single buyer may be present when a group is first formed. Another example is where only a single seller is present to offer a particular product/service. Thus, the number of buyers and sellers increase as interest grows, such that the number of buyers to be grouped increases, the products/services offered for sale increase, the like, or a combination thereof.

By way of explanation and not limitation, in operation, a buyer can log into the proximity based purchasing system 200 using one of the buyer devices 204. The log-in can include a user name and password, such that each buyer (e.g., individual, family, business, etc.) has an account with the service provider. The location of the buyer device 204 can be determined and the desired product/service can be selected. Once the location and desired product/service are determined, the buyer can be grouped. If a seller provided quotes, then the quotes can be communicated from the main controller 202 and displayed on the buyer device 204. Additionally or alternatively, if a seller did not provide a quote, then the seller's information can be displayed on the buyer device 204 and a quote can be requested or a desired price can be inputted by the buyer. The group of buyers can select a product/service from a seller based upon the price, a satisfaction rating of the seller, the like, or a combination thereof.

Further, a seller can log into the proximity based purchasing system 200 using one of the seller devices 206. The log-in can include a user name and password, such that each seller (e.g., individual, family, business, etc.) has an account with the service provider. The seller can provide quotes for products/services that they are offering to buyers, display available products/services with or without pricing, or a combination thereof. Once a group of buyers selects a product/service from a seller, the transaction can be completed, which can include a service fee paid by the group of buyers to the service provider, a commission paid by the seller to the service provider, the like, or a combination thereof.

For purposes of explanation and not limitation, in addition to the above-described embodiments or alternative thereto, buyers that promote a product/service and/or a seller to other buyers can receive a discount (e.g., ten percent (10%) discount, free, etc.) after soliciting a predetermined number of new buyers to a group (e.g., two (2) or more new buyers). Thus, there can be a multi-level marketing plan, since buyers can increase their savings by introducing new buyers to a group for a product/service. Another example of increasing revenue can be where buyers are flexible (e.g., agree to common dates of service for products/services). Yet another example can be where buyers receive an additional discount based upon a reduction in shipping if the grouped buyers agree to have the product/service delivered to one location. Thus, since all the buyers are within a proximity, the buyers can then go to the agreed upon location rather than paying for the product/service to be delivered to each individual buyer's location.

Advantageously, the method 100 and system 200 can be configured to group buyers by a geographical location that all want a similar products/service, such that discount pricing can be received by the buyers. Further, the sellers benefit by having a group of buyers identified that are all within a geographical location. It should be appreciated by those skilled in the art that the method 100 and system 200 can have additional or alternative advantages not explicitly stated herein. It should further be appreciated by those skilled in the art that the method 100 and system 200 can include various combinations of steps and components not explicitly described herein.

Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

1. A method for proximity based purchasing with a mobile device, said method comprising the steps of:
determining a product/service desired by at least a portion of a plurality of buyers;
determining a geographical location of the plurality of buyers based upon radio-frequency (RF) identification determined by a mobile device associated with each of the plurality of buyers; and
grouping the plurality of buyers by said determined geographical location and said desired product/service, such that a seller provides said product/service at a discounted rate as a result of said grouped buyers being in a geographical region that is substantially proximate to the seller and a buyer wanting a similar product/service.

2. The method of claim 1 further comprising the step of negotiating said discounted rate by at least one of said grouped buyers.

3. The method of claim 1 further comprising the step of paying a commission to a service provider by said seller.

4. The method of claim 1, wherein said determined geographical location is also based upon at least one of:
a five digit zip code;
a nine digit zip code;
a country;
a street;
a city;
a state;
a school district;
a voting district;
a county;
at least a portion of a mailing address;
global positioning satellite (GPS) system coordinates;
a location determined by a cellular connection; and
an area code.

5. The method of claim 1 further comprising the step of providing a tiered quote by said seller prior to said buyers being grouped.

6. The method of claim 1 further comprising a step of assigning a satisfaction rating to each seller.

7. The method of claim 1 further comprising the step of selecting a seller by said group of buyers based upon at least one of said discounted rate and a satisfaction rating.

8. The method of claim 1 further comprising the step of purchasing access to said seller by at least a portion of said plurality of buyers.

9. A method of proximity based purchasing using a mobile device, said method comprising the steps of:
determining a product/service desired by at least a portion of a plurality of buyers based upon the radio-frequency (RF) identification, that can be delivered by a seller in a substantially short time period with no delivery delay;
determining a geographical location of a plurality of buyers based on radio-frequency (RF) identification established by a mobile device;
grouping said plurality of buyers by said determined geographical location and said desired products/service, such that a seller provides said product/service at a discounted rate as a result of said grouped buyers being proximate to the seller's geographical region and wanting a similar product/service;
providing a tiered quote by said seller to grouped buyers; and
paying a commission to a service provider by said seller.

10. The method of claim 9 further comprising the step of negotiating said discounted rate by at least one of said grouped buyers.

11. The method of claim 9, wherein said determined geographical location is also based upon at least one of:
a five digit zip code;
a nine digit zip code;
a country;
a street;
a city;
a state;
a school district;
a voting district;
a county;
global positioning satellite (GPS) system coordinates;
a location determined by a cellular connection; and
an area code.

12. The method of claim 9 further comprising a step of assigning a satisfaction rating to each seller.

13. The method of claim 9 further comprising the step of selecting a seller by said group of buyers based upon at least one of said discounted rate and a satisfaction rating.

14. The method of claim 9 further comprising the step of purchasing access to said seller by at least a portion of said plurality of buyers.

15. A system configured for proximity based purchasing using a mobile device, said system comprising:
a main controller in communication with a plurality of buyer devices, wherein at least a portion of said plurality of buyer devices comprise:
a service selection device configured for selection of a desired product/service that can be rapidly delivered by a seller;
a location determination device configured to determine a geographical location of said buyer's mobile device based on radio-frequency (RF) identification;
a mobile communication device configured for communication with said main controller; and
wherein said main controller is configured to group said buyer devices by said determined RF identification location and said selected product/service, such that a seller provides a product/service at a discounted rate as a result of said grouped buyer devices being in a geographical region proximate to the buyer and wanting a similar product/service.

16. The system of claim 15, wherein said location determination device is configured to at least one of receive a user entered location or determine said location via an automation device.

17. The system of claim 15, wherein said location determination device also determines said location based upon at least one of:
a five digit zip code;
a nine digit zip code;
a country;
a street;
a city;
a state;
a school district;
a voting district;
a county;
at least a portion of a mailing address;
global positioning satellite (GPS) system coordinates;
a location determined by a cellular connection; and
an area code.

18. The system of claim 15, wherein said grouped buyers purchase covers to said main controller.

19. The system of claim 15, wherein said sellers provide a tiered quote that is accessed by grouped buyers via said main controller.

20. The system of claim 15, wherein said main controller is configured to provide a satisfaction rating to each seller.
